(19) United States
(12) Patent Application Publication
(10) Pub. No.: US 2024/0245048 A1
(43) Pub. Date: Jul. 25, 2024

(54) Climbing Treestand

(71) Applicant: Andrae D'Acquisto, Bellevue, IA (US)

(72) Inventor: Andrae D'Acquisto, Bellevue, IA (US)

(21) Appl. No.: 18/445,751

(22) Filed: Jan. 15, 2024

Related U.S. Application Data
(60) Provisional application No. 63/576,134, filed on Jan. 18, 2023.

(51) Int. Cl. A01M 31/02

(52) U.S. Cl. CPC A01M 31/02

(57) ABSTRACT

The present invention relates to a climbing treestand that is lighter and easier to use. More particularly, the invention is directed to a micro-climbing tree stand for aiding a hunter in climbing a tree, and for supporting the hunter above the ground in the tree.

The present application claims priority of U.S. provisional application No. 63/576,134 filed on Jan. 18, 2023.

### FIELD OF THE INVENTION

The present invention is generally related to a lighter, sleeker climbing treestand. More particularly, the invention is directed to a climbing tree stand for aiding a hunter in climbing a tree, and for supporting the hunter above the ground in the tree.

### BACKGROUND OF THE INVENTION

It is well understood by deer hunters that an advantage may be gained by elevating themselves well above the deer, such as up in a tree. When the hunter is in an elevated position, a deer is less likely to see or smell the hunter. The elevated position also gives the hunter a better view of the approaching deer and many times a better shooting angle. Although there are several climbing treestands are available in the market, many are heavy and bulky and difficult to carry long distances in the woods. Therefore, there is a need for a lighter, less bulky climbing treestand that can be carried long distances and is easy to use.

### SUMMARY OF THE INVENTION

The present invention relates to a climbing treestand that is lighter, stronger and easier to use. More particularly, the invention is directed to a micro-climbing tree stand for aiding a hunter in climbing a tree having a recessed seat and a larger useable platform area.

### BRIEF DESCRIPTIONS OF THE DRAWINGS

Further advantages of the invention will become apparent by reference to the detailed description of preferred embodiments when considered in conjunction with the drawings, which are not to scale, wherein like reference characters designate like or similar elements throughout the several drawings as follows:

FIG. 1 is a perspective view of micro-climbing tree stand 1 attached to a tree 4 according to a preferred embodiment of the invention.

FIG. 2 is a top view of the seat member of the micro-climber of the invention with recess/cut out area (on right) compared to a conventional seat member without a recess or cut out area on left 10.

FIG. 3 is a top view of the seat member placed on top of the platform member of the micro-climber of the invention showing how much additional area of the platform member the hunter can utilize when standing.

FIG. 4 is a top view of a conventional seat member placed on top of the platform member showing the platform area available to the hunter.

FIG. 5 shows the stabilizing member 14 of the micro-climber of the invention that doubles as a climbing stirrup for the hunter.

FIG. 6 is a side by side view of the platform member of the micro climber according to the invention (on right) compared to platform member of a conventional climber on left.

FIG. 7 shows the seat member of the present micro climber nested with the platform member of the micro climber of the invention.

FIG. 8 shows the plug grommet 11 and receiving port 12 utilized to securely nest the seat member to the platform member when folded up for transport.

FIG. 9 shows an alternate view of the dual-purpose stabilizer member 14 that doubles as a climbing stirrup.

FIG. 10 shows the seat member 6 of the invention with a bolt having a flattened end 16 inserted in same.

FIG. 11 shows the flattened end of said bolt 16 of the seat member inserted into the slotted receiving port 17 of the platform member which when the flattened end of the bolt is twisted and or tightened, securely fastens the seat member to the platform member.

FIG. 12 shows the reinforced flip up seat cushion configured to fit over the recessed area of the seat member.

FIG. 13 shows a close-up view of the slotted receiving port 17 of the platform member.

FIG. 14 shows a close-up view of the flattened end of said bolt 16 of the seat member inserted into the slotted receiving port 17 of the platform member which is twisted securely fasting the seat member to the platform member.

FIG. 15 shows a close-up view of the stabilizing member 16 of the micro-climber of the invention that doubles as a climbing stirrup with recessed areas 18 for the hunters/users shoes or boots for the hunter.

### DETAILED DESCRIPTION OF THE INVENTION

The climbing treestand of the invention comprises an upper hand climbing support member that doubles as a seat, also referred to as a seat member, and a lower platform member. The upper seat member includes a support frame having substantially parallel and opposing first and second upper support arms that are joined to a transverse rail. The rear of the seat member comprises a series of teeth designed to engage a tree when in use. The upper seat member also includes attachment means, generally a strap that attaches at one end to the first upper support arm, wraps around the trunk of the tree, and attaches at the other end to the second upper support arm, which when tightened, secures the seat member to the tree in a position that is substantially horizontal and perpendicular to the tree.

In one embodiment of the invention the seat member is characterized by a recess or cut out area which, when the hunter stands up, allows the hunter to access to a larger useable portion of the platform member. Specifically, the present seat member allows for better use of a larger area of the climbing platform due to the recess area/cut out of the seat member. This allows for a smaller platform member which lightens the overall weight of the climbing treestand of the invention. The recess area can be semi-circular, semi-elliptical, multi-angled, semi hexagonal, semi pentagonal, semi-octagonal boxed, and the like. This open concept seat design provides the hunter with a lighter overall treestand, more standing room on the platform, and allows the hunter to stand closer to the tree providing better concealment when hunting.

The seat member can also be accessorized with a flip up, reinforced seat cushion configured to fit over said recessed area of the seat member giving the hunter a comfortable, cushioned seat. When the hunter stands the reinforced seat cushion can easily and quickly be flipped up allowing the hunter to take full advantage of the recessed area of the seat and greater use of the platform.

The seat member can be used as a hand climber option wherein the hunter can use the seat member to hold on and pull up pull up the platform member with his/her feet or can optionally comprise a sit and climb bar which provides the hunter a bar to sit on and pull up the platform as he/she snakes up a tree.

The platform member is positioned on the tree below the seat member and comprises a lower support frame having substantially parallel and opposing first and second lower support arms joined to the outer edges of the platform member. The transverse platform is disposed between the first and second lower support arms, and near the bottom of the lower support frame. The rear of the platform member also comprises a series of teeth designed to engage the tree when climbing. Like the upper seat member, the platform member also comprises attachment means, generally an engagement strap that attaches on one end to the first lower support arm, wraps around the trunk of the tree, and attaches at the other end to the second lower support arm. When cinched tightly, the lower tree-engagement strap pulls the top of the lower support frame toward and adjacent to the trunk of the tree, thereby causing the lower support frame to be cantilevered on the lower, such that the transverse platform is suspended outward and away from the trunk of the tree in a substantially horizontal position perpendicular to the tree or pole to which it is attached.

The upper seat member and lower platform member are also characterized by a unique system for securing said members together for transport. More specifically the seat member comprises a threaded or unthreaded bolt, thumb screw or the like having a flattened end. The platform member comprises a slotted receiving port configured to receive said flattened end of said bolt or thumb screw, wherein when said bolt or screw is inserted into said slotted receiving port and twisted and/or tightened down, the seat and platform members are securely fastened to each other.

In another embodiment the seat member or section comprises one or more grommets, preferable two or more grommets and said platform member comprises one or more receiving ports, preferably an equal number of receiving ports for receiving said grommets of said seat member. The grommets and receiving ports, when nested together, i.e., when said grommets are inserted into said receiving ports, the seat member and the platform member are securely fastened to each other. The invention also contemplates the reverse arrangement wherein the platform member or section comprises one or more grommets, preferable two or more grommets and said seat member comprises one or more receiving ports, preferably an equal number of receiving ports for receiving said grommets of said platform member.

The attachment means employed with said seat member and said platform member can be in the form of a strap, belt, toothed belt, cable, chain, and the like provided that it is of sufficient strength to support the hunter utilizing the micro-climber of the invention.

The teeth on the rear of the seat member and the platform member are drafted toward the tree allowing both members to settle down when weight is applied without any additional movements. In one embodiment the teeth are angled, generally at least 5° below the horizontal plane of the platform and/or seat member, in another embodiment at least 10° below the horizontal plane of the platform and/or seat member, in another embodiment at least 15° below the horizontal plane of the platform and/or seat member, and in yet another embodiment from 20-35° below the horizontal plane of the platform and/or seat member.

When the hunter stands on the platform member, the platform teeth engage the trunk of the tree and the platform supports the hunter's weight. In this manner, the hunters's weight on the platform maintains tension on the strap encircling the tree and causes the teeth of the platform to be firmly pressed into the trunk of the tree. This secures the platform to the tree even when the hunter's weight is removed from the platform. The seat member is secured to the tree in a similar fashion.

In order to prevent the seat portion and/or the platform member from disengaging from the tree and falling out of reach of the hunter it is preferred that the seat member and the platform member be attached to each other by a removable attachment strap, rope and the like.

The micro-climbing treestand of the invention provides several significant advantages over prior art designs.

### Greater Standing Room on Platform Member

The recess or cut out area of the seat member of the present climbing treestand is of open design, i.e., the seat member comprises a cut out or recess area which, when the hunter stands, allows the hunter access to a larger portion of the platform member. Specifically, the present seat member allows for better use of the full climbing platform due to the recess area/cut out of the seat member. This allows for a smaller platform member which lightens the overall weight of the climbing treestand of the invention. The recess area can be semi-circular, semi-elliptical, multi-angled, semi hexagonal, semi pentagonal, semi-octagonal boxed, and the like. This open concept seat design provides the hunter with a lighter overall treestand, more standing room on the platform, and allows the hunter to stand closer to the tree providing better concealment when hunting.

In one embodiment the recess area has a maximum depth that is from 10-70% of the total depth of the seat member; in another embodiment from 15-65%, in another embodiment from 20-60% and in yet another embodiment from about 25-55% of the total depth of the seat member. In a preferred embodiment, the recess area has a maximum depth that is at least 25% of the total depth of the seat member; in another embodiment the recess area has a maximum depth that is at least 35% of the total depth of the seat member; in another embodiment at least 40% of the total depth of the seat member; in another embodiment at least 50% of the total depth of the seat member; and in yet another embodiment at least 60% of the total depth of the seat member.

### Lighter Overall Climbing Stand

The recess or cutout area of the present climber eliminates a large amount of material in the seat thereby providing a lighter seat member in the process. Additionally, the recess area of the present seat member allows the hunter to utilize more space of the platform member when standing, which also allows for a smaller platform compared to conventional climbers while having the same platform area available to the hunter, providing a lighter platform in the process. The problem with conventional hand climber seats is that they extend outwards such that when the hunter stands, he/she is only able to utilize a small portion of the platform member due to the overhang of the seat. The open concept seat of the invention allows the hunter to have more standing room on the support platform, comfort and functionality when hunting.

### Concealment

When a hunter stands away from the tree it creates an unnatural silhouette that can easily be spotted by game animals. The open concept seat design allows a hunter to stand and remain significantly closer to the tree which largely, or in many cases substantially eliminates the unnatural silhouette of the hunter and better allows the hunter to be concealed and undetected from game animals.

### Built in Climbing Stirrup Design

Most conventional climbing platforms have a straight stabilizing bar that functions to stabilize the support arms of the platform member and prevent the support arms collapsing inward or spreading outward during use. The platform member of the present micro-climber comprises a dual use stabilizing member that also prevents the support arms from collapsing inward or spreading outward during use, but additionally comprises integrated climbing stirrups eliminating the need for adding climbing stirrups to the platform required in many prior art designs. In one embodiment the dual-purpose stabilizer of the invention is designed with a rounded recess area configured to accept the shoes/boots of the hunter/user providing a safer and more secure climbing experience. The dual-purpose stabilizer of the invention also eliminates the need for additional climbing mechanisms, such as stirrups, that are required to be added to the platform by most prior art climbers. Traditional climbing stirrups can be cumbersome and slow due to having to attach both feet to the straps individually. By not having to attach your feet into a conventional stirrup you can climb much quicker and more efficiently.

Further, with traditional climbing stirrups your feet need to remain in fixed position until you reach hunting height. This can pose difficulty when climbing and can cause the hunter to lose his/her balance. The dual-purpose stabilizer of the invention allows for a climber to easily step out and secure ones-self as he/she goes up the tree, lessens the likelihood of one losing his/her balance when climbing and increase overall stability of the platform member when climbing. Traditional stirrups that are mounted on platforms can also pose a tripping hazard due to their location or attachment position. The dual-purpose stabilizer of the invention keeps the platform completely free of the tripping hazard posed by conventional stirrups.

Finally, some climbing stands suggest inserting your feet under the hinges or assemblies of the stand to climb which avoids the use of strapped stirrups. This forces the user to angle his or her feet outward resulting in a less comfortable, and less stable climbing experience. It is also not accommodating for larger boot styles or foot size. These disadvantages are overcome by the dual use stabilizer of the invention.

In a further embodiment the dual-purpose stabilizer that doubles as climbing stirrups is attached to said platform and configured such that when said platform is collapsed for transport, the stabilizer/climbing stirrup pivots or folds to lie flat with the platform section. When collapsed, the present micro-climber is the sleekest, smallest profile and lightest climber available on the market.

In another embodiment, the platform member of the present micro-climber comprises integrated attachment points for quiet and secure transport of the micro-climber to the desired destination. In one embodiment the seat member is equipped with plug style grommets and the platform member is equipped with receiving/carrying ports which, when the micro-climber is folded up for transport, the grommets of the seat member fit snugly into the receiving/carrying ports of the platform member providing a sleekest, smallest profile climber on the market.

In its broadest embodiment the seat and platform members of the micro-climber of the invention can be made of by any process, including machining from a solid metal workpiece, including aluminum and the like, and/or by a cast aluminum process. Any form of steel, aluminum, aluminum alloy, metal/metal alloy, cast aluminum or cast aluminum alloys, carbon fiber, thermoplastic materials and the like can be used to fabricate the treestands of the invention provided that they are sufficient strength and not excessively heavy. In one embodiment aluminum and alloys of aluminum are the preferred materials for fabricating the micro-climber of the invention.

One-piece cast aluminum platforms are the benchmark for a one-piece lightweight treestand platform and or seat. However today, there is high demand for even lighter weight treestands. The strongest currently available material practically employed in fabricating cast treestand platforms is 356t6 aluminum. Such castings are hardened and have suitable size and weight strength ratio for the largest hunters.

In another embodiment to obtain a lighter treestand platform is to use a non-casted platform and/or seat machined from one-piece plate stock. This machining process allows one fabricate platforms that are much lighter and stronger than cast platforms. Examples of acceptable plate aluminum stock include but is not limited to aluminum grade 6061 which is hardened/strengthened aluminum plate and other aluminum grades having the same or greater strength to weight ratios.

In one preferred embodiment of the invention the platform and/or seat member are each or collectively fabricated from a single aluminum workpiece by machining or by a waterjet process, optionally an abrasive waterjet process or by a laser cutting process. In one embodiment the micro-climber of the invention is fabricated with an abrasive water jet process allows one to make platforms that are stronger and lighter in that it allows one to reduce the wall thicknesses of the platform and still achieve the strength needed. Accordingly, the one-piece platforms of the invention made by waterjet process are among the strongest and lightest platforms in the industry. The waterjet process allows for the fabrication of a one-piece treestand platform that is stronger, lighter and potentially cheaper to make than cast aluminum platforms. Similar benefits are realized by fabricating the treestand seat a waterjet process, in one embodiment an abrasive waterjet process.

In another embodiment, similar benefits are realized by machining the one-piece platform and/or one-piece seat of the present micro-climber.

The platform member and/or seat member of the invention comprises an open grate-like pattern characterized by a plurality of irregularly shaped openings which vary substantially in size, shape and orientation in the horizontal plane of the platform and/or seat members. The variations in the openings are in directions both radially from the center of the tree and tangentially to the tree trunk. As mentioned above, in one embodiment the platform member of the invention also comprises carrying or locking ports that are configured to receive and attach the seat member to the platform member.

### DETAILED DESCRIPTION OF A PREFERRED EMBODIMENT

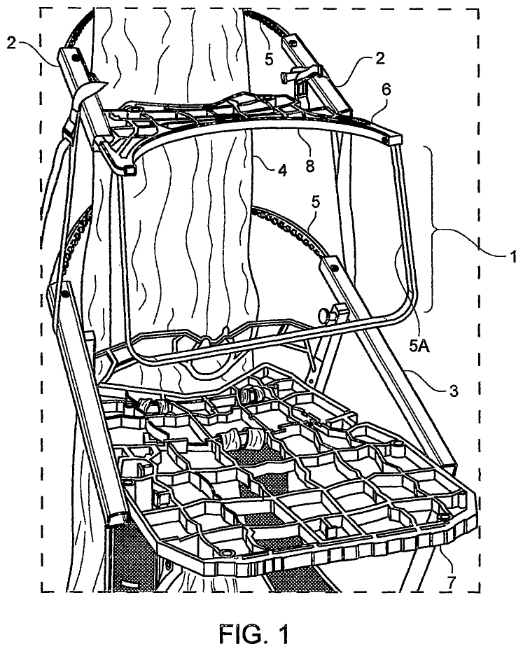

FIG. 1 shows a preferred embodiment of the micro-climber 1 of the present invention. The micro-climber 1 comprises a seat member 6 and a platform member 7, each of which includes support arms/assemblies, i.e., an upper support assembly 2 and the lower support assembly 3. The stand 1 may be used for aiding an operator in climbing the trunk of a tree or pole 4, and for comfortably supporting the weight of the operator at an elevated position on the tree or pole. The recess area 8 of the seat member 6 is also depicted in FIG. 1.

The upper support arms 2 and lower support arms 3 generally comprises support frame and a tree-engagement strap 5. The support arms 2 and 3 are substantially parallel and are movable to change their angles as needed. The support arms 2 and 3 can also collapse into a substantially flat position on the same plane as the seat member and/or platform member so that the seat member and platform member can be folded flat for easy transport.

A tree-engagement strap 5 is attached at one end to the support arm 2 of the seat member 6, is wrapped around the trunk of the tree 4, and is attached at its other end to the support arm 2 securing the seat member 6 to the tree. In a similar fashion, tree-engagement strap 5 is attached at one end to the support arm 3 of the platform member 7, is wrapped around the trunk of the tree 4, and is attached at its other end to the other support arm 3 securing the platform 7 to the tree.

The strap 5 comprises a stranded metal cable, such as may be used in aircraft control systems, covered by flexible tubing, such as nylon tubing. In another embodiment, the strap 5 comprises a flexible steel band or cable. One skilled in the art will appreciate that the invention is not limited to any particular material used in forming the straps of the invention, as long as the chosen material can handle the structural load.

As depicted in FIG. 1, when the straps 5 are cinched tightly about the tree 4 the ends of the support arms are pulled toward the tree. As the ends of the support arms 2 and 3 are pulled toward the tree 4, and the teeth located at the rear of the seat member 6 and platform member 7 engage the trunk, suspending the seat member 6 and platform member 7 in a position substantially horizontal position perpendicular to the tree. A sit and climb bar 5A is also shown.

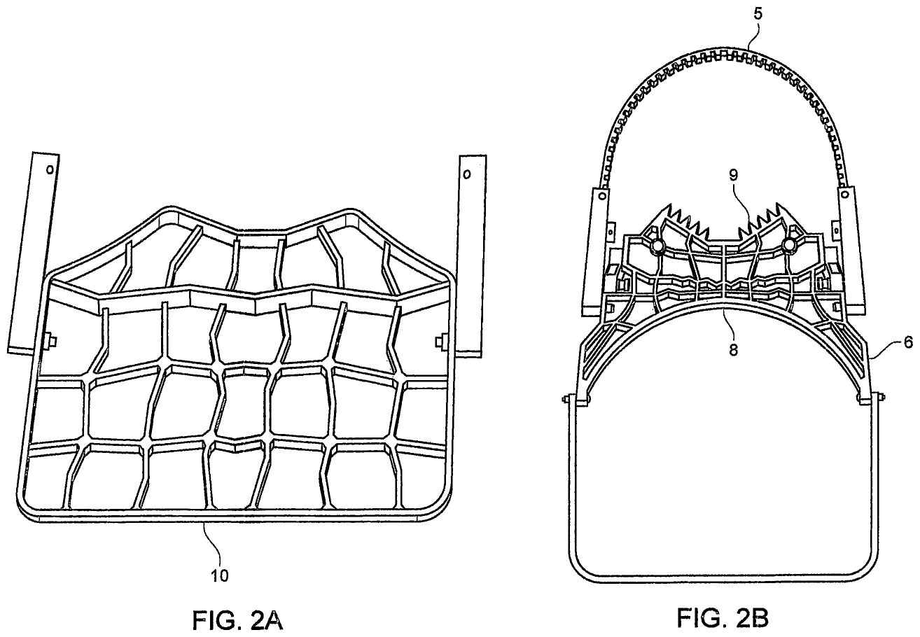

FIG. 2 shows the seat member of the invention on the right, with the recess area 8, engagement teeth 9 and securing strap 5 depicted, compared to a convention seat design 10 with no recess area.

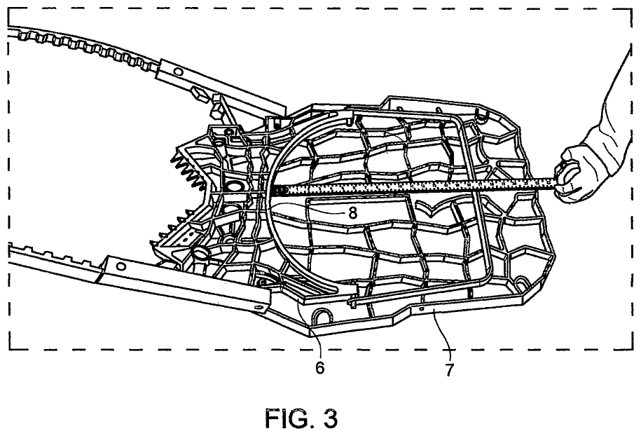

FIG. 3 shows the seat member 6 with elliptical recess area 8 on top of the platform member 7 illustrating the increased platform space available to the hunter. In this embodiment approximately 23 inches of platform area is available to the hunter.

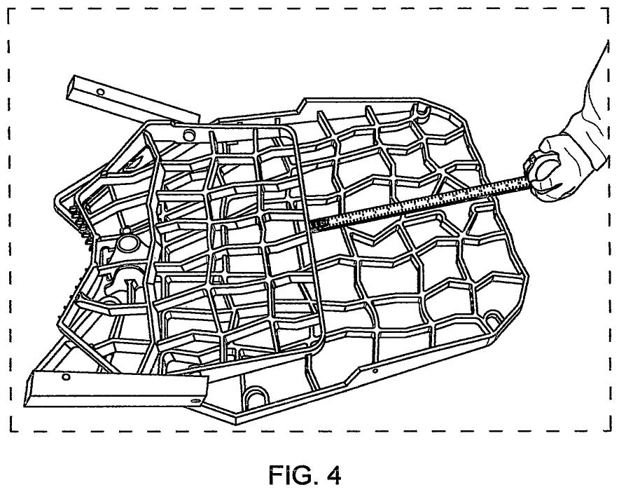

FIG. 4 illustrates a conventional seat member placed on top of the platform member illustrating the platform space is able to be utilized by the hunter. As seen by FIG. 3 the elliptical recess of the seat member of the invention allows the hunter to utilize approximately 23 inches of platform space. FIG. 4 showing a conventional platform and seat only allows the hunter approximately 15 inches of platform space. The extra 8 inches of platform space afforded by the invention is extremely useful to the hunter and provides the option of utilizing a smaller platform, if desired, further reducing the weight of the micro climber of the invention.

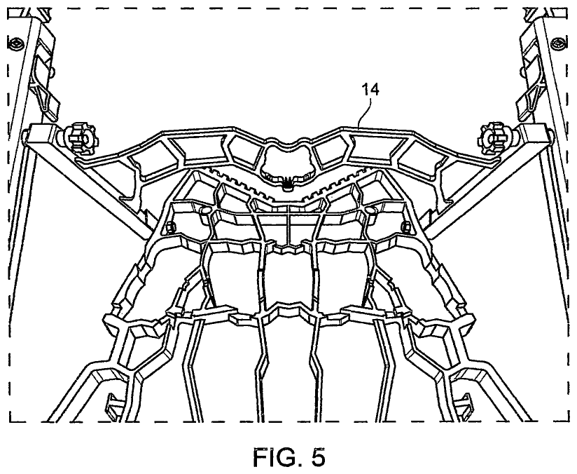

FIG. 5 shows the dual-purpose stabilizing bar with built in foot stirrups 14 which allows the hunter to safely and easily pull the platform member up when climbing a tree.

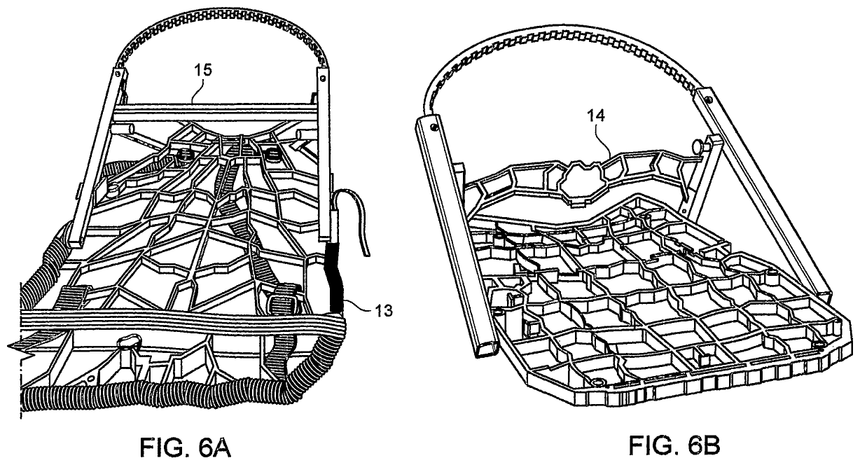

FIG. 6 is a side by side view of the platform member 7 of the micro climber according to the invention (on right) compared to platform member of a conventional climber 13. FIG. 6 also depicts the dual-purpose stabilizer of the invention 14 compared to the straight stabilizer bar of the prior art 15.

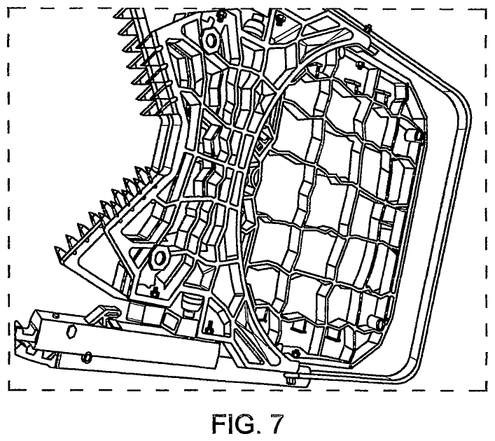

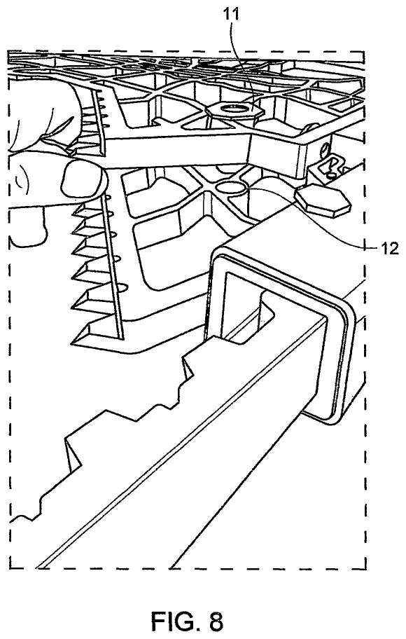

FIG. 7 shows the platform member of the present micro climber nested with the platform member of the micro climber of the invention, while FIG. 8 is a close up view of one of the plurality of plug grommets 11 and receiving ports 12 which, when the plug grommets of the seat member 6 are inserted into the receiving ports of the platform member 7, securely nests the seat member to the platform member when they are folded up for transport.

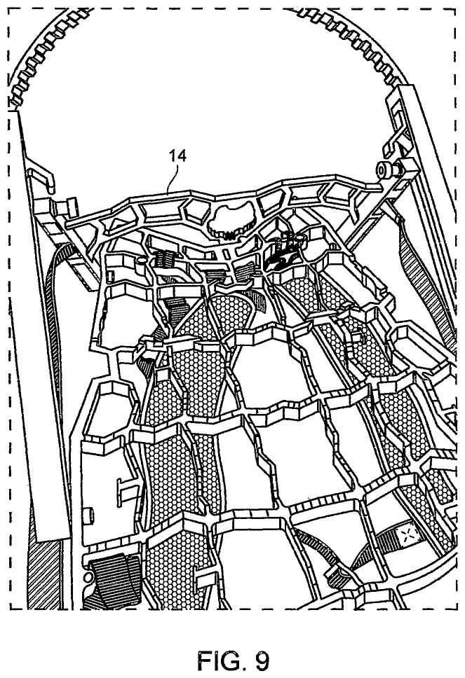

FIG. 9 shows an alternate view of the dual-purpose stabilizer member 14 that doubles as a climbing stirrup.

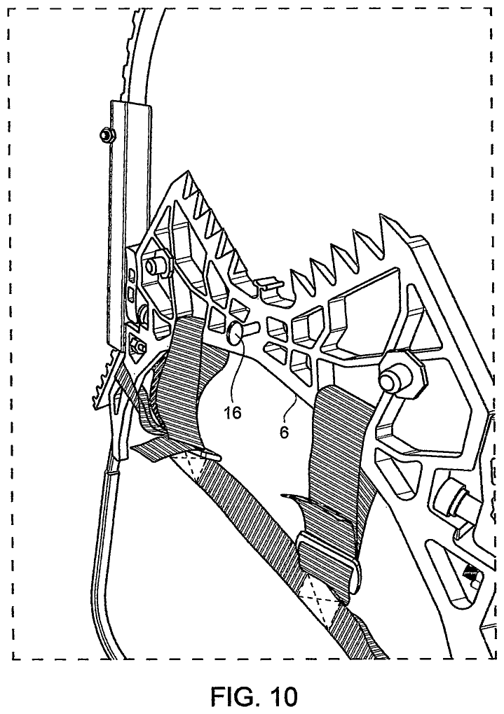

FIG. 10 shows the seat member 6 of the invention with a bolt having a flattened end 16 inserted in same.

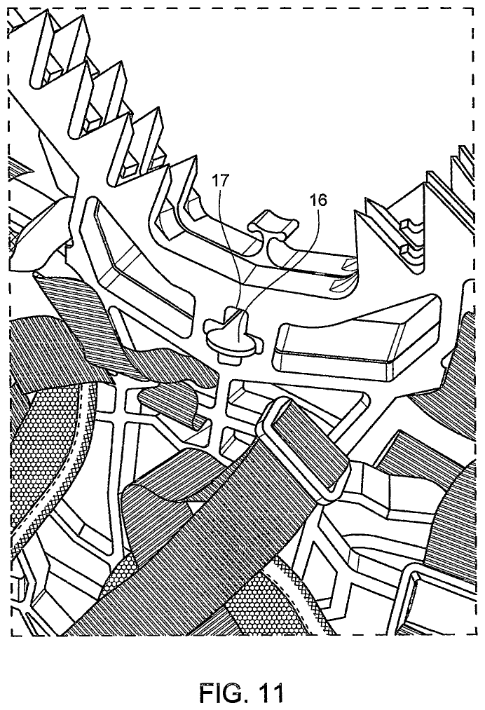

FIG. 11 shows the flattened end of said bolt 16 of the seat member 6 inserted into the slotted receiving port 17 of the platform member 7 which when the flattened end of the bolt is twisted and or tightened, securely fastens the seat member 6 to the platform member 7.

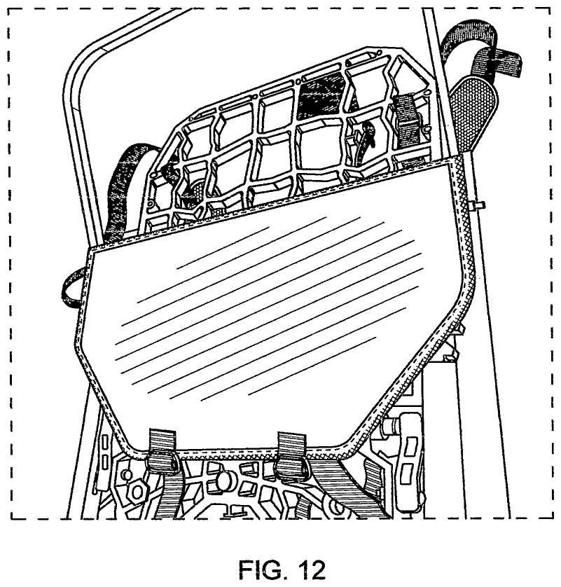

FIG. 12 shows the reinforced flip up seat cushion configured to fit over the recessed area of the seat member.

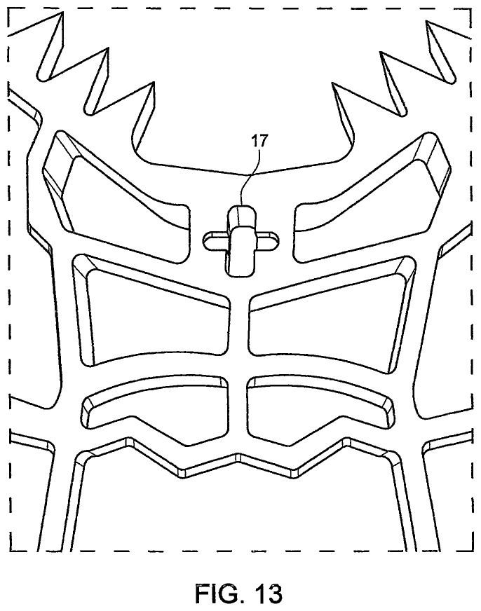

FIG. 13 shows a close-up view of the slotted receiving port 14 of the platform member 7.

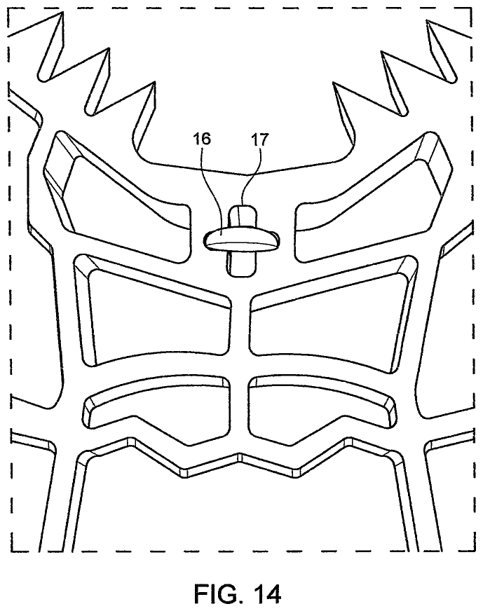

FIG. 14 shows a close-up view of the flattened end of said bolt 16 of the seat member 6 inserted into the slotted receiving port 17 of the platform member 7 which is twisted securely fasting the seat member 6 to the platform member 7.

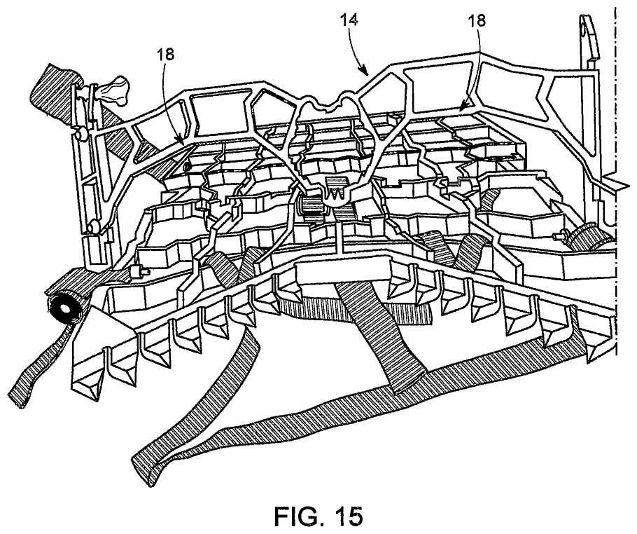

FIG. 15 shows a close-up view of the stabilizing member 14 of the micro-climber of the invention that doubles as a climbing stirrup for the hunter. The recessed areas 18 of the climbing stirrups are also shown.

During use, the platform member 7 and seat member 6 are both attached to the tree proximate to its base several feet apart with the tree-engagement straps 5. With the hunter facing the tree, the hunter's feet are place in the dual-purpose stabilizing bar 14. With the hunter's feet inserted in the dual purpose stabilizing bar 14 and the seat member 6 is placed at approximate chest high level when the hunter is standing on the platform member 7. The hunter pushes down on the seat member 6 while pulling his knees toward his chest, thereby lifting up on the dual-purpose stabilizing bar 14 with his feet, lifting the platform 7 in the process. The upward movement of the dual-purpose stabilizing bar 14 causes the teeth 9 of the platform 7 to disengage from the trunk of the tree such that the platform member 7 is free to be moved upward. After moving the platform 7 up as far as comfortable/possible, the hunter eases his weight back down on the platform member 7 so that the teeth 9 of said platform member 7 re-engages the tree. The hunter then lifts upward on the seat member 6 which disengages the teeth 9 of said seat member 6 from the tree so that the seat member 6 is free to move upward. After lifting the up as far as comfortable/possible, generally at around chest level, the hunter again presses down with his arms so that the teeth 9 of the seat member 6 again firmly engage the tree. With the hunter's feet inserted in the dual-purpose stabilizing bar 14 and the seat member 6 placed at approximate chest high level, the hunter again pushes down on the seat member 6 while pulling his knees toward his chest, thereby lifting up on the dual-purpose stabilizing bar 14 with his feet, lifting the platform 7 in the process. The upward movement of the in the dual-purpose stabilizing bar 14 causes the teeth 9 of the platform 7 to disengage from the trunk of the tree such that the platform member 7 is free to move upward. After moving the platform 7 up as far as comfortable/possible, the hunter eases his weight back down on the platform member 7 so that the teeth 9 of said platform member 7 re-engages the tree. This process is repeated until the operator has reached the desired height in the tree.

Alternatively, the seat member 6 can be placed a bit higher and the hunter, while hanging on the seat 6, can pull the platform member 7 upward by lifting up on the dual purpose stabilizing bar 14 lifting the platform 7 in the process. This process is repeated until the hunter reaches the desired height in a tree.

In another embodiment the seat member 6 can be equipped with a sit and climb bar 5A to assist in climbing a tree. During use, the platform member 7 and seat member 6 are both attached to the tree proximate to its base several feet apart by the tree-engagement straps 5 With the hunter facing the tree, the hunter's feet are place in the dual-purpose stabilizing bar 14 and the hunter sits on the sit and climb bar 5A. While sitting, the hunter pulls his knees toward his chest, thereby lifting up on the dual-purpose stabilizing bar 14 with his feet, lifting the platform 7 in the process. The upward movement of the dual-purpose stabilizing bar 14 causes the teeth 9 of the platform to disengage from the trunk of the tree such that the platform member 7 is free to be moved upward. After moving the platform 7 up as far as comfortable/possible, the hunter eases his weight back down on the platform member 7 so that the teeth 9 of said platform 9 member re-engages the tree. The hunter then lifts upward on the seat member 6 which disengages the teeth 9 of said seat member 6 from the tree so that the seat member 6 is free to move upward. After lifting the up as far as comfortable/possible, generally at around chest level, the hunter sits down on the sit and climb bar 5A so that the teeth 9 of the seat member 6 again firmly engage the tree. With the hunter's feet inserted in the dual-purpose stabilizing bar 14 and the seat member 6 placed at approximate chest high level, the hunter pulls his knees toward his chest, thereby lifting up on the dual-purpose stabilizing bar 14 with his feet, lifting the platform 7 in the process. This process is repeated until the hunter reaches the desired height in the tree. The process, whether by the hand climbing method or the sit and climb method, is reversed when the hunter is descending the tree.

A safety line should be used at all times when using any climbing treestand including the micro-climber of the invention.

It is contemplated and will be apparent to those skilled in the art from the preceding description and the accompanying drawings that modifications and/or changes may be made in the embodiments of the invention. For example, although the preferred material for many of the load-bearing structures in the stand is aluminum or alloys comprising aluminum, other materials could be used, such as steel or other metals or alloys, or composite materials, including carbon fiber materials. The invention is not limited to any particular type of material or construction technique. Accordingly, it is expressly intended that the foregoing description and the accompanying drawings are illustrative of preferred embodiments only, not limiting thereto, and that the true spirit and scope of the present invention be determined by reference to the appended claims.

I claim:

1. A climbing treestand for demountable attachment to the trunk of a tree, said treestand comprising:
a lower main supporting platform member,
an upper seat member, and
attachment means connected to each of said platform member and seat member for attaching each of said seat member and platform member to a tree,
wherein the seat member comprises a recess cutout which provides the user with more standing room on said support platform and said platform member comprises a dual-purpose stabilizer that doubles as a climbing stirrup.

2. The climbing treestand of claim 1 wherein said cutout recess is semi-circular, semi-elliptical, elliptical, multi-angled, semi hexagonal, semi pentagonal, semi-octogonal, boxed, and the like.

3. The climbing treestand of claim 1 wherein the recess area has a maximum depth that is from 10-70% of the maximum depth of the seat member.

4. The climbing treestand of claim 1 wherein the recess area has a maximum depth that is from 15-65% of the maximum depth of the seat member.

5. The climbing treestand of claim 1 wherein the recess area has a maximum depth that is from 20-60% of the maximum depth of the seat member.

6. The climbing treestand of claim 1 wherein the recess area has a maximum depth that is at least 50% of the maximum depth of the seat member.

7. The climbing treestand of claim 1 wherein said platform member comprises support arms on each outer edge of said platform, wherein said support arms are connected to each other by a stabilizer member that comprises integrated climbing stirrups.

8. The climbing treestand of claim 1 wherein said platform member comprises a plurality of attachment ports configured to allow attachment of said seat member to said platform member.

9. The climbing treestand of claim 8 wherein said seat member comprises a plurality of plug grommets configured to be inserted into the attachment ports of said platform member to securely attach said seat member to said platform member.

10. The climbing treestand of claim 1 wherein said platform and/or the seat member are one-piece and are fabricated from cast aluminum or solid aluminum stock.

11. The climbing treestand of claim 10 wherein said platform and/or seat member are fabricated from solid aluminum stock by machining or by a waterjet process.

12. The climbing treestand of claim 1 wherein the upper seat member comprises a threaded or unthreaded bolt or thumb screw having a flattened end, and the platform member comprises a slotted receiving port configured to receive said flattened end of said bolt or thumb screw, wherein when said bolt or screw is inserted into said slotted receiving port and twisted and/or tightened down, the seat and platform members are securely fastened to each other.

13. The climbing treestand of claim 1 wherein said dual-purpose stabilizer comprises rounded recess areas configured to accept the shoes/boots of the user.

14. The climbing treestand of claim 13 wherein said dual purpose stabilizer is configured such that when said platform member is collapsed for transport, the stabilizer/climbing stirrup pivots or folds to lie flat with the platform member.
